(19) United States
(12) Patent Application Publication
(10) Pub. No.: US 2025/0030247 A1
(43) Pub. Date: Jan. 23, 2025

(54) PRE-CHARGE CIRCUIT AND CONTROL SYSTEM FOR A POWER CONVERTER

(71) Applicant: Eaton Intelligent Power Limited, Dublin (IE)

(72) Inventors: Mahesh Mysore Swamy, Gurnee, IL (US); Hua Qiang Li, Menomonee Falls, WI (US)

(21) Appl. No.: 18/764,660

(22) Filed: Jul. 5, 2024

Related U.S. Application Data
(60) Provisional application No. 63/527,927, filed on Jul. 20, 2023.

(51) Int. Cl. H02J 3/36; H02M 1/14; H02M 7/5387

(52) U.S. Cl. CPC H02J 3/36; H02M 1/143; H02M 7/53871

(57) ABSTRACT

A power converter includes an electrical network including a plurality of intermediate nodes. Each intermediate node is configured to connect to one phase of an alternating current (AC) electrical power source, the electrical network is configured to convert AC electrical current to direct current (DC) electrical current, and the electrical network includes a plurality of electronic switches. The power converter also includes a DC link electrically connected to the electrical network; a pre-charge path electrically connected to the DC link, the pre-charge path including a pre-charge impedance; a control path electrically connected to one of the electronic switches, the control path including a relay; and a control system configured to analyze a 10 plurality of electrical measurements from the power converter to determine a status output; and determine whether to control the relay to change state based on the status output.

### CROSS-REFERENCE TO RELATED APPLICATION

This application claims priority to U.S. Provisional Application No. 63/527,927, filed on Jul. 20, 2023, and titled PRE-CHARGE CIRCUIT AND CONTROL SYSTEM FOR A POWER CONVERTER, which is incorporated herein by reference in its entirety.

### TECHNICAL FIELD

This disclosure relates to a pre-charge circuit and control system for a power converter.

### BACKGROUND

A power converter, such as a variable speed drive, an adjustable speed drive, or an uninterruptable power supply, may be connected to an alternating current (AC) high-power electrical distribution system, such as a power grid. The power converter may drive, power, and/or control, for example, an electric machine or a power electronic load. The electrical apparatus includes an electrical network that converts AC power to direct-current (DC) power or DC power to AC power.

### SUMMARY

In one aspect, a power converter includes an electrical network including a plurality of intermediate nodes. Each intermediate node is configured to connect to one phase of an alternating current (AC) electrical power source, the electrical network is configured to convert AC electrical current to direct current (DC) electrical current, and the electrical network includes a plurality of electronic switches. The power converter also includes a DC link electrically connected to the electrical network; a pre-charge path electrically connected to the DC link, the pre-charge path including a pre-charge impedance; a control path electrically connected to one of the electronic switches, the control path including a relay; and a control system configured to analyze a plurality of electrical measurements from the power converter to determine a status output; and determine whether to control the relay to change state based on the status output.

Implementations may include one or more of the following features.

The plurality of electrical measurements from the power converter may include: an indication of a voltage across the pre-charge impedance, an indication of a voltage of the AC power source, and an indication of a voltage across the DC link; and the control system may be configured to analyze the indication of a voltage across the pre-charge impedance, the indication of a voltage of the AC power source, and the indication of a voltage across the DC link to generate the status output.

The plurality of electronic switches may include at least one controllable electronic switch electrically connected to each intermediate node; the control path may include a plurality of control branches; each control branch may include a relay; and each control branch may be electrically connected to a control node of one controllable electronic switch. The control system may be configured to determine whether to control all of the relays to change state based on the status output. The controllable electronic switch may include a thyristor; and the control node may include a gate on the thyristor. The pre-charge path may be electrically connected to one of the intermediate nodes and the DC link. The pre-charge path may include a plurality of pre-charge branches, and each pre-charge branch may be electrically connected to one of the intermediate nodes and the pre-charge impedance. The power converter also may include a voltage sensing impedance electrically connected to the input nodes. The plurality of electrical measurements may include an indication of a voltage across the pre-charge impedance, an indication of a voltage of the AC power source measured at the voltage sensing impedance, and an indication of a voltage across the DC link.

The relay may include a contactor.

The plurality of electronic switches may include diodes, and two diodes may be electrically connected to each intermediate node; the relay may be in series with one of the diodes; and the pre-charge impedance may be in parallel with the relay.

The plurality of electronic switches may include diodes, and two diodes may be electrically connected to each intermediate node; the control path may include a plurality of control branches, each control branch may include a relay in series with one of the diodes; and the pre-charge path may include a plurality of pre-charge paths, each pre-charge path may include a pre-charge impedance in parallel with one of the relays.

In another aspect, a control system includes: an analysis module configured to analyze a plurality of electrical measurements from a power converter to determine a status output; and a control module configured to determine whether to turn on a relay in a control path of the power converter based on the status output. Electrical current is provided to a DC link of the power converter through a pre-charge path when the relay is off, and turning on the relay causes one or more electronic switches in the power converter to conduct current such that electrical current is provided to the DC link of the power converter through a power path when the relay is on.

Implementations may include one or more of the following features.

To analyze the plurality of electrical measurements, the analysis module may be configured to compare each electrical measurement to a pre-determined condition associated with that electrical measurement to produce a result for that electrical measurement; and the status output may include the result for each electrical measurement.

The control module may be configured to turn on the relay only if each result meets the associated pre-determined condition such that electrical current is provided to the DC link of the power converter through the power path only when each electrical measurement meets the associated pre-determined condition.

In another aspect, an apparatus includes: an electrical network including: a plurality of intermediate nodes, where each intermediate node is configured to connect to one phase of an alternating current (AC) electrical power source, the electrical network is configured to convert AC electrical current to direct current (DC) electrical current; and an electrical network including a phase branch connected to each intermediate node, each phase branch including a thyristor and a diode; a DC link electrically connected to the electrical network; a pre-charge path electrically connected to at least one of the intermediate nodes and the DC link, the pre-charge path may include a pre-charge impedance; and a plurality of control paths, each control path connected to one of the intermediate nodes and a gate of one of the thyristors, and each control path including a relay.

Implementations may include one or more of the following features.

The pre-charge path may be connected to all of the intermediate nodes.

The apparatus also may include a sensing impedance connected to all of the intermediate nodes, and a voltage across the sensing impedance may provide an indication of a voltage input to the apparatus.

In another aspect, a method includes: accessing a plurality of electrical measurements from a power converter, the plurality of measurements including: an indication of a voltage across a pre-charge impedance; an indication of a voltage of an AC power source connected to the power converter, and an indication of a voltage across a DC link of the power converter; comparing at least two indications to an associated specification to produce at least two status outputs; analyzing the at least two status outputs to determine whether to change a state of a relay in the power converter; if it is determined to turn on the relay, controlling the relay to turn on to thereby cause electrical current to flow in an electronic switch connected to the relay such that electric current flows through a power path to the DC link, the power path including the electronic switch; and if it is determined to turn off the relay, controlling the relay to turn off such that electric current flows through a pre-charge impedance to the DC link.

In some implementations, each indication is compared to an associated specification to produce three status outputs, and the three status outputs are analyzed to determine whether to change the state of the relay.

Implementations of any of the techniques described herein may include an apparatus, a device, a system, a control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power system.

FIG. 2 is a schematic of a system that includes an example of a power converter.

FIG. 3 is a flow chart of an example of a process that may be used with a power converter.

FIGS. 4-8 are schematics of systems that each include an example of a power converter.

FIG. 9 is a schematic of an example of a system that includes a rectifier and a DC link.

### DETAILED DESCRIPTION

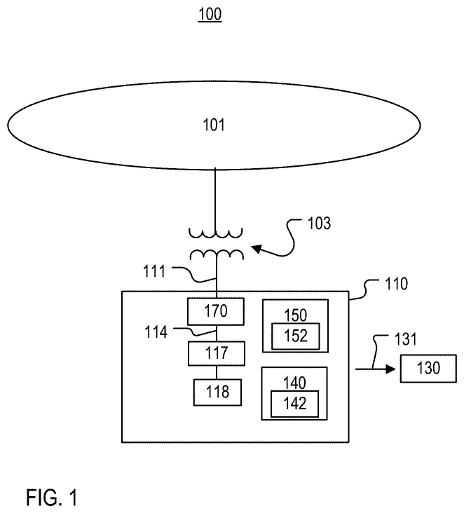

FIG. 1 is a block diagram of an example of a power system 100. The power system 100 includes a power converter 110 that is electrically connected to a power distribution network 101 at an input node 111. The power converter 110 includes a filter system 170, a rectifier 117, a DC link 118, a pre-charge path 140 that includes a pre-charge impedance 142, a control path 150 that includes a relay 152, and a control system 130. The filter system 170 is between the input node 111 and an intermediate node 114. The rectifier 117 includes electronic elements arranged and/or controlled to convert alternating current (AC) or time-varying power from the power distribution network 101 to direct current (DC) power that is provided to the DC link 118. The rectifier 117 is any sort of arrangement that converts AC current to DC current. The rectifier 117 includes a plurality of switches (for example, diodes) and the switches may or may not be controllable switches (such as transistors and thyristors). For example, the rectifier 117 may be a diode bridge rectifier or a diode-thyristor hybrid rectifier.

The electrical power distribution network 101 may be, for example, a three-phase electrical power grid that provides electricity to industrial, commercial, and/or residential facilities. The AC electrical power distribution network 101 distributes AC electrical power that has a fundamental frequency of, for example, 50 or 60 Hertz (Hz). The distribution network 101 may be a low-voltage distribution network with an operating voltage of up to 1 kilovolt (kV).

In the example of FIG. 1, the power system 100 includes a transformer 103 between the input node 111 and the electrical power distribution network 101. The transformer 103 steps-down or reduces the voltage of the distribution network 101 such that the AC voltage at the input node 111 is lower than the voltage of the distribution network 101. For example, the voltage at the input node 111 may be 240 V. The power system 100 may be implemented without the transformer 103.

The DC link 118 includes one or more energy-storing devices such as, for example, capacitors. During operational use of the power converter 110, the DC link 118 receives DC current from the rectifier 117 and stores electrical energy such that a potential difference in the form of a voltage develops across the DC link 118. However, when the power converter 110 is powered on, there is no or little voltage across the DC link 118. Thus, when the power converter 110 is turned on, the voltage across the DC link 118 is much less than the voltage at the input node 111, and this voltage difference can cause transient inrush currents to flow in the rectifier 117. The inrush currents may be short-lived but large enough in amplitude to damage components in the power converter 110. To reduce these transient inrush currents at start up, the DC link 118 is first charged through the pre-charge path 140 in a pre-charge sequence. After the pre-charge sequence is complete, the control system 130 commands the relay 152 to close, bypassing the pre-charge path 140. After the pre-charge path 140 is bypassed, electric current flows in a power path through the electronic elements of the rectifier 117 and the power converter 110 operates in steady-state.

As discussed below, the control system 130 analyzes a plurality of distinct electrical measurements 131 from the power converter 110 to determine when to close the relay 152. The electrical measurements 131 include an indication of the voltage across the DC link 118, an indication of the voltage across the pre-charge impedance 142, and an indication of the voltage at the intermediate node 114. The voltage across the DC link 118 is the DC bus voltage and the voltage at the intermediate node 114 is the voltage of the input AC source.

Some traditional power converters include pre-charge paths that are bypassed based only on an evaluation of the voltage across the DC link. However, such an approach is unable to efficiently handle brown-out and brown-in conditions. A brown-out condition occurs when the peak voltage of any one phase of the input voltage suddenly drops below the voltage of the DC link due to, for example, an upstream electrical fault. During the brown-out, the DC link remains connected to the power path until the voltage of the DC link discharges to or below the pre-defined value. When the DC link has discharged to the pre-defined value, the DC link is removed from the power path and connected to pre-charge path.

However, the amount of time for the DC link to discharge to the pre-defined value is often longer than the duration of the brown-out condition. In this scenario, when the brown-out condition ends and the input voltage is restored (also referred to as brown-in), the pre-charge path is not connected to the DC link and the pre-charge sequence does not occur because the voltage across the DC link did not fall to the pre-defined value. However, even if the voltage across the DC link did not fall to the pre-defined value, the voltage across the DC link is reduced during the brown-out such that a voltage differential exists between the input voltage and the DC link when the input power is restored during brown-in. Moreover, during brown-in, the amplitude of the input voltage may be greater than typical and more variable than typical. Thus, a relatively large voltage differential may exist between the DC link and the input voltage after a brown-out even in cases in which the DC link did not fully discharge during the brown-out condition. This voltage differential can lead to large in-rush currents.

On the other hand, the control system 130 analyzes each of the electrical measurements 131 to determine whether or not to bypass the pre-charge path 140. By analyzing all of the electrical measurements 131, the control system 130 is able to avoid or mitigate in-rush currents during startup of the power converter 110 and during brown-out and brown-in conditions.

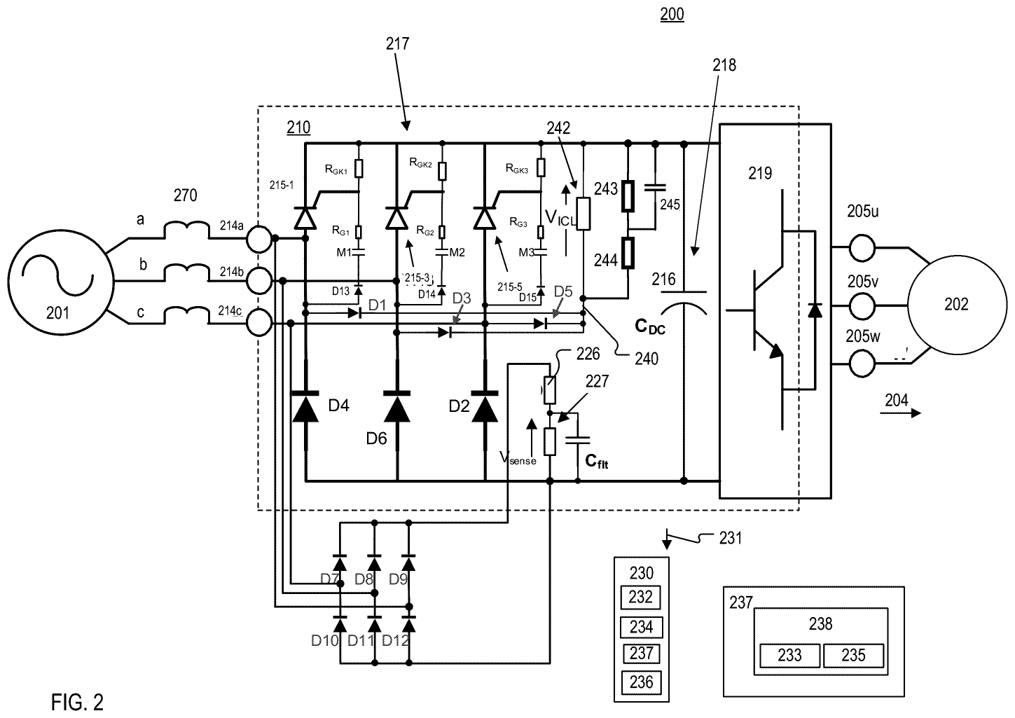

FIG. 2 is a schematic of a system 200. The system 200 includes a power converter 210 that is connected to a load 202 and a three-phase AC electrical power distribution network 201. The load 202 may be, for example, an induction motor or a permanent magnet synchronous machine. The dashed lines are used to show groupings of components, and the dashed lines do not necessarily represent physical objects. However, the power converter 210 may be in a housing or enclosure, such as a rack-mountable box or a cabinet.

The electrical power distribution network 201 distributes AC electrical power that has a fundamental frequency of, for example, 50 or 60 Hertz (Hz). The distribution network 201 may include, for example, one or more transmission lines, distribution lines, electrical cables, and/or any other mechanism for transmitting electricity. The distribution network 201 includes three phases, which are referred to as a, b, and c. Each phase a, b, c has a respective grid voltage Va, Vb, Vc.

The power converter 210 includes input nodes 211a, 211b, 211c, each of which is electrically coupled to one of the three phases (a, b, c) of the distribution network 201. The power converter 210 also includes intermediate nodes 214a, 214b, 214c. The power converter 210 includes a rectifier 217, a DC link 218, and an inverter 219. The rectifier 217 includes electronic switches arranged and/or controllable to convert AC currents ia, ib, ic at the nodes 214a, 214b, 214c into DC current Idc that flows to the DC link 218.

The power converter 210 also includes a filter system 270. The filter system 270 may be, for example, an inductor between each input node and respective intermediate node (such as shown in FIG. 2), and may or may not include additional electronic components. Other implementations of the filter system 270 are possible and the filter 270 is not necessarily located between the input nodes 211a, 211b, 211c and the intermediate nodes 214a, 214b, 214c. For example, the filter system 270 may be implemented as a DC link choke between the rectifier 217 and the DC link 218.

The DC link 218 includes an energy storage apparatus 216. The energy storage apparatus 216 is any component capable of storing electrical energy. The energy storage apparatus 216 may be, for example, a capacitor, or a network made of a collection of such devices. In some implementations, the energy storage apparatus 216 includes one or more electrolytic capacitors.

The rectified current Idc charges the energy storage apparatus 216, which stores energy in the form of voltage. In the example of FIG. 2, the energy storage apparatus 216 is a capacitor labeled Cdc.

The inverter 219 modulates the energy stored in the energy storage apparatus 216 into a three-phase AC voltage and current driver signal 204 that is provided to the load 202. The inverter 219 includes output terminals 205u, 205v, 205w, each of which is connected to one of the three phases of the load 202. The voltage that appears across the terminals 205u, 205v, 205w becomes the three-phase AC voltage driver signal 204. The inverter 219 includes a network of electronic switches (for example, power transistors) that are arranged to generate the AC voltage driver signal 204. The inverter 219 may be controlled based on a pulse width modulation (PWM) control scheme.

The rectifier 217 is a diode-thyristor hybrid rectifier that includes thyristors 215-1, 215-3, 215-5 and diodes D4, D6, D2. The thyristor 215-1 and the diode D4 are electrically connected to the intermediate node 214a and the DC link 218. The thyristor 215-3 and the diode D6 are electrically connected to the intermediate node 214b and the DC link 218. The thyristor 215-5 and the diode D2 are electrically connected to the intermediate node 214c and the DC link 218. A thyristor includes a cathode, an anode, and a gate. When the cathode is negatively charged relative to the anode, no current flows in the thyristor until current is applied to the gate. When current is applied to the gate, the thyristor conducts current until the voltage between the cathode and the anode is reversed or reduced below a threshold or holding value. The thyristor has three states: forward conducting (current is applied to the gate and the thyristor conducts forward current), forward blocking (the thyristor blocks the flow of forward current despite voltage being applied in a direction that would cause a diode to conduct current), and reverse blocking (the thyristor blocks the flow of reverse current). Each thyristor 215-1, 215-3, 215-5 may be a silicon controlled rectifier (SCR). The power converter 210 also includes relays M1, M2, M3. Each relay MI, M2, M3 has two states: on (or closed) and off (or open). The control system 230 controls the state of the relays M1, M2, M3. The relay MI is connected to the intermediate node 214a through a diode D13 and to the gate of the thyristor 215-1. The relay M2 is connected to the intermediate node 214b through a diode D14 and to the gate of the thyristor 215-3. The relay M3 is connected to the intermediate node 214c through a diode D15 and to the gate of the thyristor 215-5. When the relays M1, M2, M3 are off (or open), gate current is not provided to the thyristors 215-1, 215-3, 215-5. When the relays M1, M2, M3 are on, gate current is provided to the thyristors 215-1, 215-3, 215-5.

The relays M1, M2, M3 may be, for example, contactors. The gate current for the thyristors 215-1, 215-3, 215-5 is relatively small, for example, in the range of ones to tens of milliamps (mA). Thus, the relays M1, M2, M3 may be rated for a relatively low current are not large sized, heavy-duty contactors (for example, single-pole, double-throw contactors). As a result, the power converter 210 does not include a separate gate driver board for the thyristors 215-1, 215-3, 215-5. This allows the power converter 210 to have an overall smaller footprint, lower weight, fewer parts, and cost less than a power converter that includes a separate gate driver board.

The power converter 210 also includes a pre-charge path 240 that includes a pre-charge impedance 242, a voltage divider that includes resistances 243 and 244, and a capacitor 245 in parallel with the resistor 243.

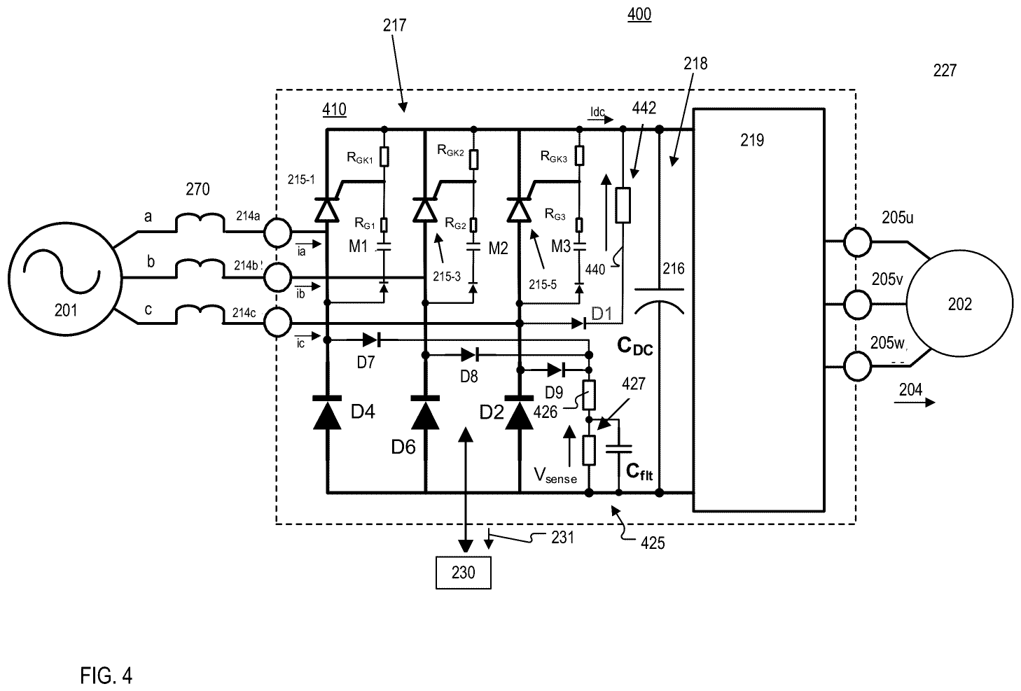

The pre-charge impedance 242 may be a resistor or an inrush current limiter (ICL). The pre-charge path 240 is connected to the intermediate nodes 214a, 214b, and 214c such that all three phases of the input voltage are used to pre-charge the DC link 218. Although fewer than all input voltage phases may be used to pre-charge the DC link 218 (such as the single-phase example shown in FIG. 4), using all three phases of the input voltage to pre-charge the DC link 218 provides more electrical current to the DC link 218 and reduces the pre-charge time. For example, using all three phases of the input voltage to charge the DC link 218 is about three times faster than using one phase of the input voltage.

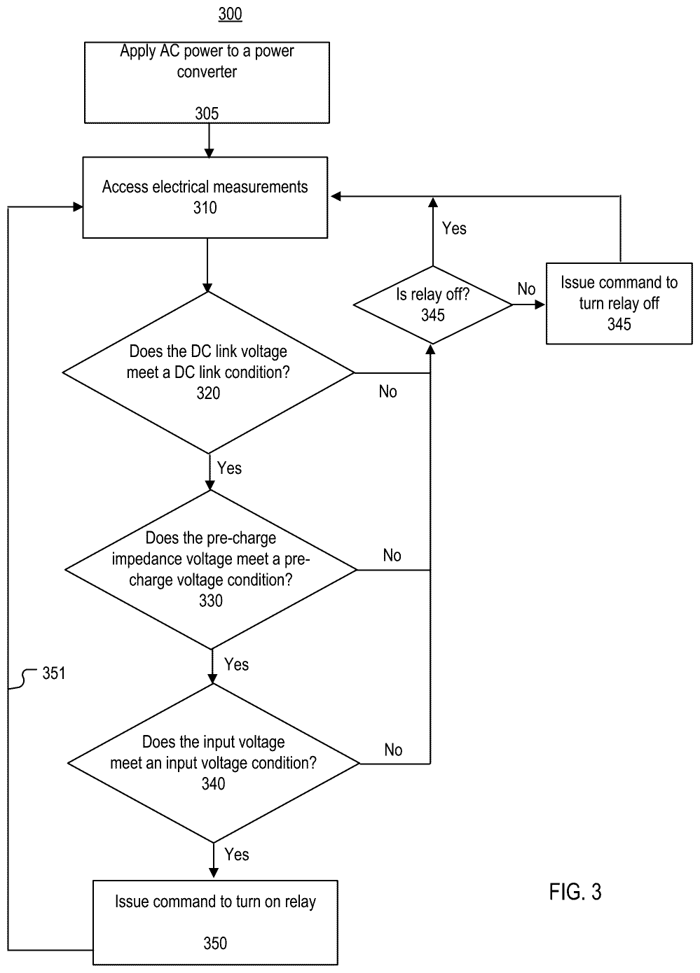

Furthermore, using fewer than all of the phases of the input voltage to pre-charge the DC link 218 may cause a ripple in the voltage across the pre-charge impedance 242. The presence of the ripple can result in the value for the indication V_{ICL} (the voltage across the pre-charge impedance 242) being inaccurate, which in turn may decrease the accuracy of the comparison between the indication V_{ICL} and the pre-charge impedance voltage condition in the process 300 (discussed below with respect to FIG. 3).

The pre-charge path 240 includes three branches that connect to the pre-charge impedance 242 as follows: a diode D1 that is connected to the intermediate node 214a and the pre-charge impedance 242, a diode D3 that is connected to the intermediate node 214b and the pre-charge impedance 242, and a diode D5 that is connected to the intermediate node 214c and the pre-charge impedance 242. With this configuration, when AC power is applied to the power converter 210, at least one of the diodes D1, D3, D5 is forward biased and conducting current at any given time such that current is constantly or nearly constantly flowing through the pre-charge impedance 242 and into the DC link 218 during the pre-charge sequence. The diodes D1, D3, and D5 and the pre-charge impedance 242 are rated for relatively low currents compared to the contactors that are used in the pre-charge path of some legacy approaches.

When the relays M1, M2, M3 are off, current flows in the pre-charge path 240. When the relays M1, M2, M3 are on, the pre-charge path 240 is bypassed, and the thyristors 215-1, 215-3, 215-5 are in the forward conducting state and can conduct current. Current flows in the thyristors 215-1, 215-3, 215-5 (in a power path) because the pre-charge impedance 242 has a much greater impedance than the thyristors.

The power converter 210 also includes a sensing circuit 225. The sensing circuit 225 includes a low power 3-phase diode bridge rectifier connected to the intermediate nodes 214a, 214b, and 214c, respectively. The 3-phase diode bridge rectifier includes diodes D7, D8, D9, D10, D11, and D12. A voltage divider resistor 226 with a sensing resistor 227 is used for sensing the health of the input AC voltage. Filter capacitor Cflt is used across resistor 227 to reduce electrical noise interference. The negative of the external sensor circuit is same as the negative DC bus of the power converter 210 as shown in FIG. 2. The voltage across the resistor 227 provides an indication of the input voltage at the intermediate nodes 214a, 214b, 214c.

The power converter 210 also includes a control system 230 that controls the relays M1, M2, M3 based on electrical measurements 231. The electrical measurements 231 are from various sensors (not shown) in the power converter 210. The sensors may include voltage sensors and/or current sensors (for example, hall-effect sensors, current transformers, and/or Rogowski coils). The electrical measurements 231 include an indication of the voltage of the DC link 218 (Vdc), an indication of the input voltage (V_{SENSE}), and an indication of the voltage (V_{ICL}) across the pre-charge impedance 242.

The indications may be direct measurements of the voltages or data from which the voltages may be derived using assumptions and/or known values. For example, the indication of the voltage of the DC link 218 (Vdc) may be a measurement from a voltage sensor that measures the voltage across the capacitor Cdc, the indication of the voltage (V_{ICL}) may be a measurement from a voltage sensor that measures the voltage across the pre-charge impedance 242, and the indication of the input voltage (V_{SENSE}) may be a measurement from voltage sensors at the nodes 214a, 214b, 214c. In another example, the indication of the input voltage (V_{SENSE}) may be a measurement of the current through the resistor 227 (which the control system 230 multiplies by the known impedance of the resistor 227 to determine V_{SENSE}), or a direct measurement of the voltage across the resistor 227. In yet another example, the indication of the voltage (V_{ICL}) may be a measurement of a current through the pre-charge impedance 242 (which the control system 230 uses to derive the value of V_{ICL}).

A logic block 237 of the control system 230 analyzes the electrical measurements 231 to determine whether to turn on the relays MI, M2, M3. The control system 230 also includes an electronic processing module 232, an electronic storage 234, and an input/output (I/O) interface 236. The control system 230 may be implemented as a microcontroller or a logic controller.

The electronic processing module 232 includes one or more electronic processors. The electronic processors of the module 232 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 234 may be any type of electronic memory. In some implementations, the electronic memory is capable of storing instructions in the form of computer programs or software. The electronic storage 234 may include volatile and/or non-volatile components. The electronic storage 234 and the processing module 232 are coupled such that the processing module 232 is able to access or read data from and write data to the electronic storage 234. The electronic storage 234 stores instructions that, when executed, cause the electronic processing module 232 to analyze data and/or retrieve information.

The I/O interface 236 is any interface that allows a human operator, another device, and/or an autonomous process to interact with the control system 230. The I/O interface 236 may include, for example, pins, ports, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 236 also may allow communication without physical contact through, for example, an IEEE 802.11, Bluetooth, or a near-field communication (NFC) connection. The control system 230 and/or the information stored on the electronic storage 234 may be, for example, operated, configured, modified, or updated through the I/O interface 236.

The I/O interface 236 also may allow the control system 230 to communicate with components in the system 200 and with systems external to and remote from the system 200. For example, the I/O interface 236 may include a communications interface that allows communication between the control system 230 and a remote station (not shown), or between the control system 230 and a separate monitoring apparatus. The remote station or the monitoring apparatus may be any type of station through which an operator is able to communicate with the control system 230 without making physical contact with the control system 230. For example, the remote station may be a computer-based work station, a smart phone, tablet, or a laptop computer that connects to the control system 230 via a services protocol, or a remote control that connects to the control system 230 via a radio-frequency signal.

The logic block 237 includes an analysis module 238. The logic block 237 may be implemented by a collection of logic gates. A logic gate is a device that performs a logic operation on one or more inputs to produce an output. The logic gates in the logic block 237 may be implemented with electronic gates (for example, transistors and/or operational amplifiers) or in software.

The analysis module 238 analyzes the electrical measurements 231. The analysis module 238 includes a comparator 233 for each electrical measurement. Thus, for implementations in which the electrical measurements 231 include three distinct measurements, the analysis module includes three comparators 233. Each comparator 233 is configured to compare one of the electrical measurements 231 to a corresponding reference value or condition. Each comparator 233 may be an electronic device or physical logic gate, such as, for example, an operational amplifier, that outputs a binary value by comparing two input values. In some implementations, each comparator 233 is implemented in software as executable instructions that are stored on the electronic storage 234. For example, the comparator 233 may be a subtraction operation that calculates a difference between two input values followed by a comparison operation that compares the difference to a pre-determined threshold to produce a binary output value. Regardless of how the comparators 233 are implemented, the two input values to each comparator are one of the electrical measurements (Vdc, V_{ICL}, or V_{SENSE}) and the corresponding condition or reference value.

The binary output of each comparator 233 is provided to an AND block 235. The AND block 235 may be implemented as a physical logic gate or in software. When the binary output of all of the comparators 233 is high (for example, 1), the output of the AND block 235 is high. Otherwise, the output of the AND block 235 is low (for example, 0). The control system 230 uses the output of the AND block 235 to determine whether to operate the relays M1, M2, M3, as discussed in more detail with respect to FIG. 3. For example, the control system 230 may include a relay driver that generates a relay control signal and applies the relay control signal to the relays M1, M2, M3 when the output of the AND block 235 is high.

The discussion above relates to the power converter generating the AC driver signal 204 and providing the AC driver signal 204 to the load 202. However, other configurations and applications are possible. For example, the bi-directional power converter 210 may be implemented without the inverter 219 and configured to drive a DC load.

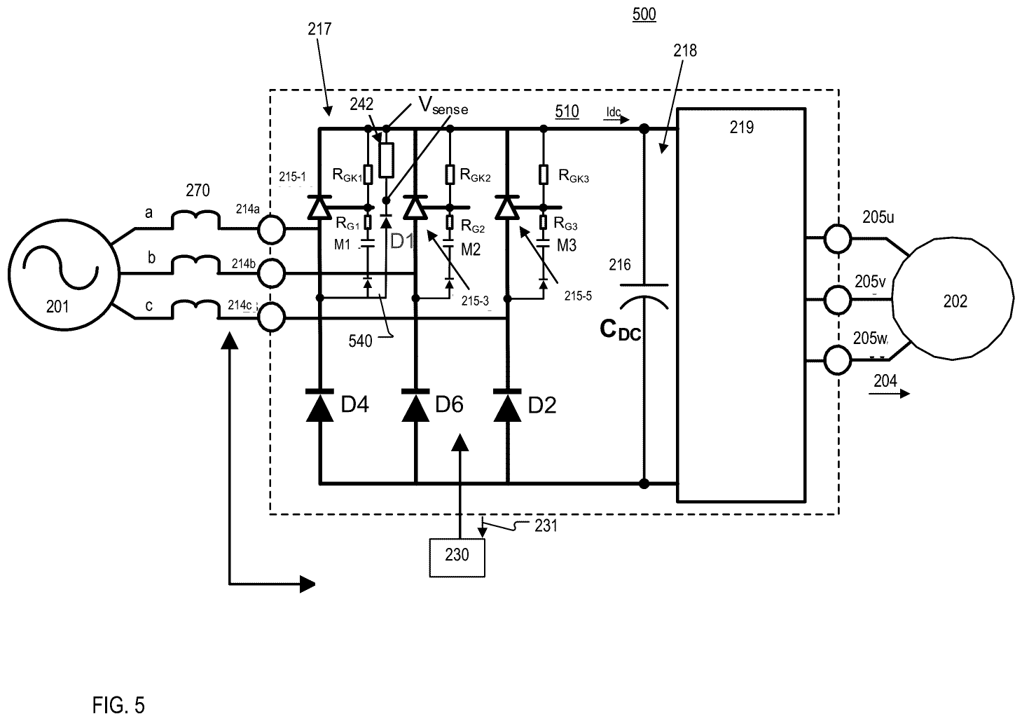

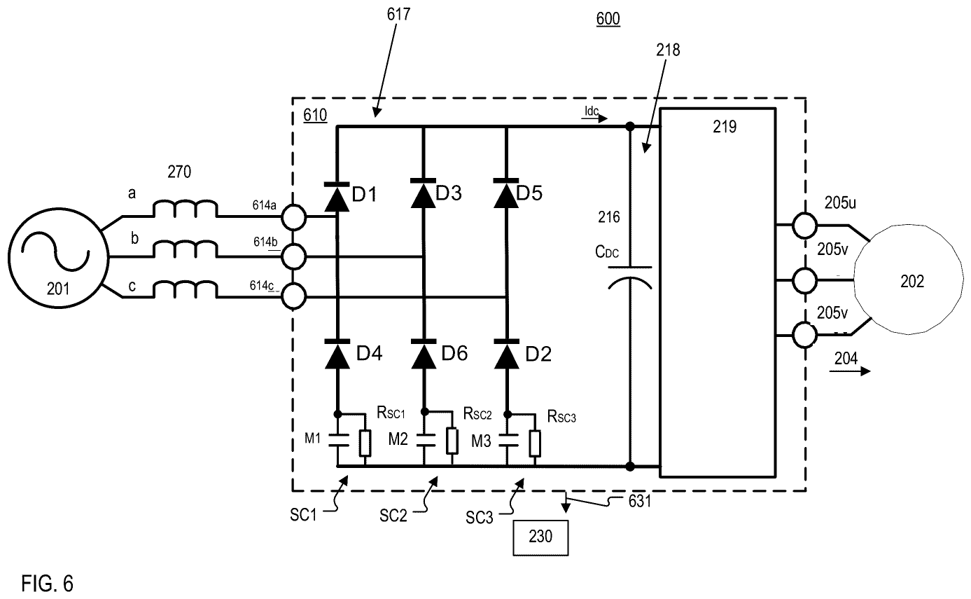

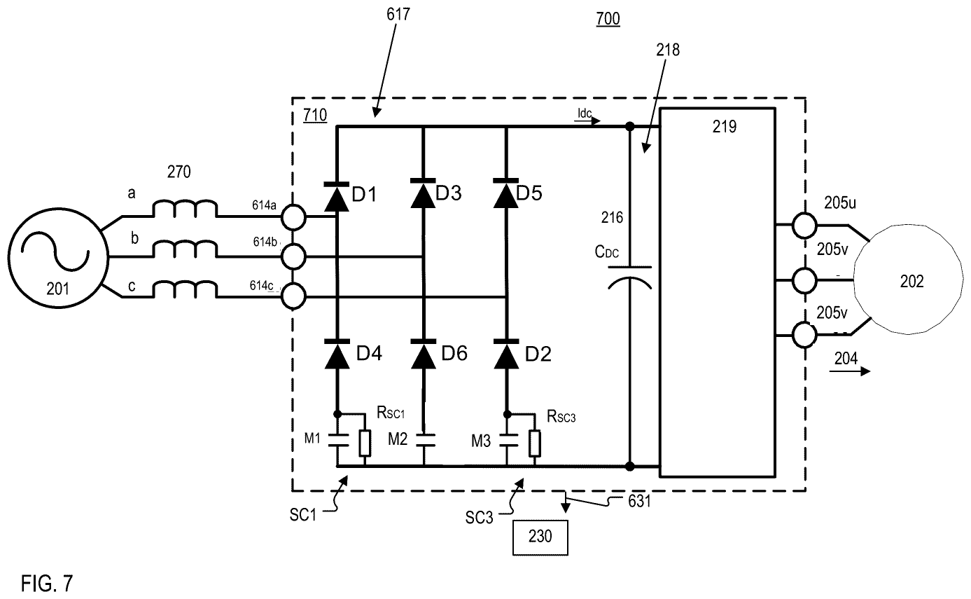

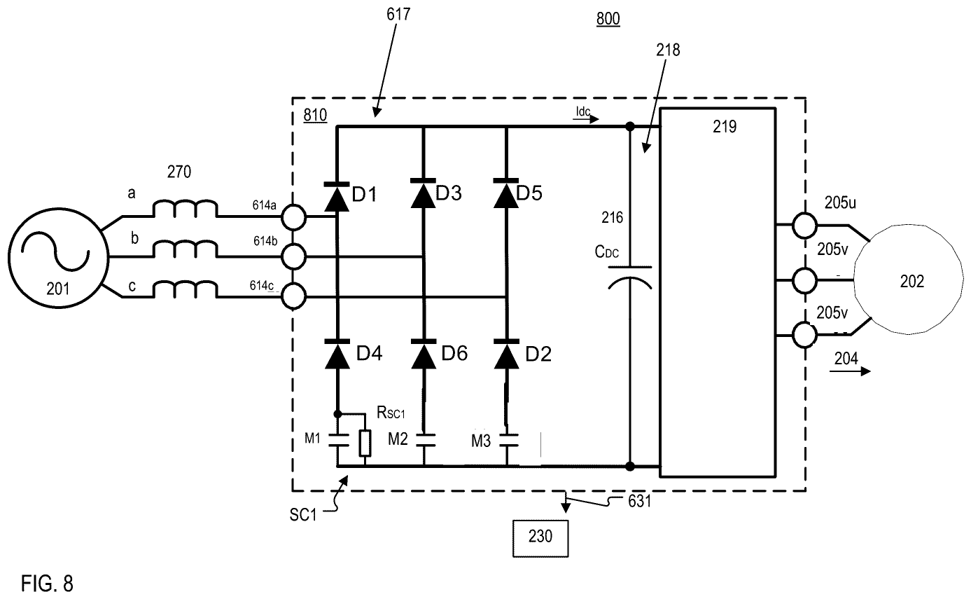

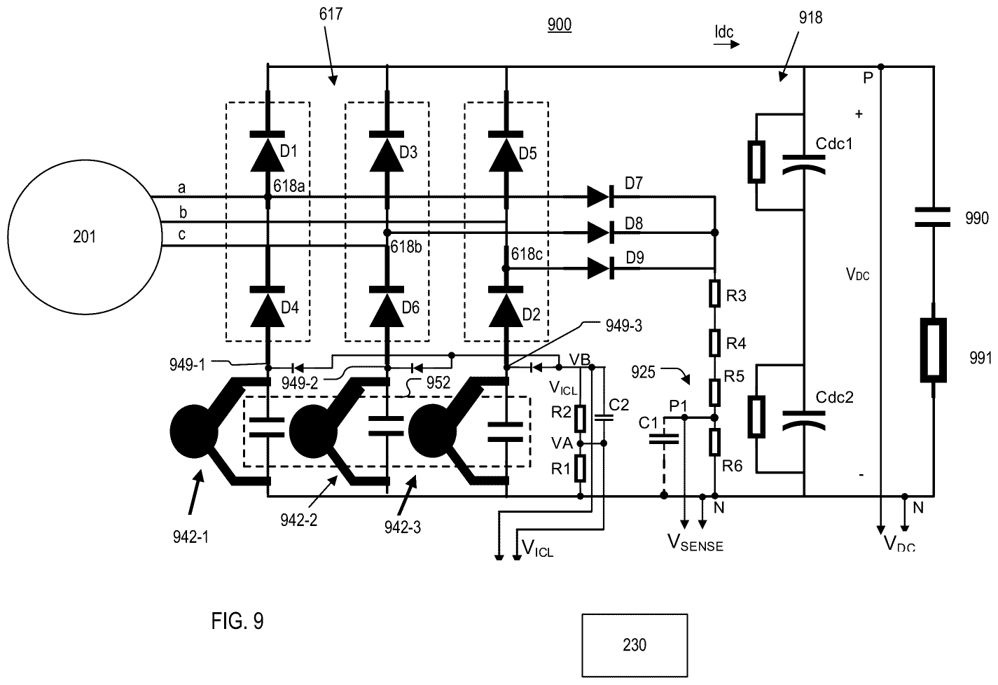

FIG. 3 is a flow chart of a process 300. The process 300 is implemented by the logic block 237 of the control system 230. The process 300 is discussed with respect to the power converter 210 to provide an example. However, the process 300 may be used with other power converters. For example, the process 300 may be used with electrical measurements from the power converter 410 (FIG. 4), 510 (FIG. 5), 610 (FIG. 6), 710 (FIG. 7), or 810 (FIG. 8). Moreover, the process 300 may be used with the system 900 (FIG. 9).

The process 300 is initiated when AC power is applied to the power converter 210 (305). The electrical measurements 231 are accessed (310). As discussed above, the electrical measurements 231 include an indication of a voltage across the DC link 218 (Vdc), an indication of the voltage across the pre-charge impedance 242 (V_{ICL}), and an indication of the voltage at one or more of the intermediate nodes 214a, 214b, 214c (V_{SENSE}). These indicators are referred to as the indicators Vdc, V_{ICL}, V_{SENSE}.

Each indicator Vdc, V_{ICL}, V_{SENSE} is analyzed relative to a specification, reference value, or condition that is associated with that indicator to determine a status for each indicator. The status is positive or high (shown as “Yes” in FIG. 3) if the condition is met. The status is negative or low (shown as “No” in FIG. 3) if the condition is not met. The status may be a binary value with 1 representing a positive (or high) status and 0 representing a negative (or low) status.

The specifications or conditions are pre-determined and are stored on the electronic storage 234. Each specification or condition may be a threshold value that specifies a minimum or maximum voltage value, or a range of voltage values that are associated with acceptable performance. In the example of FIG. 3, the electronic storage 234 stores three conditions: a DC link condition, a pre-charge voltage condition, and an input voltage condition.

When power is applied to the power converter 210 at (305), the relays M1, M2, M3 are OFF, and gate current is not provided to the thyristors 215-1, 215-3, 215-5. Electrical current flows in the pre-charge path 240 through whichever of the diodes D1, D3, D5 is forward biased and the pre-charge impedance 242 to the DC link 218. The current charges the capacitor Cdc and returns back through either diode D2, D4, or D6. The voltage (Vdc) across the DC link 218 begins to increase.

The control system 230 analyzes the electrical measurements 231 to determine whether to turn on the relays M1, M2, M3 as follows. The indicator of the voltage (Vdc) across the DC link 218 is compared to a DC link condition (320). The DC link condition is a pre-defined voltage value. The DC link condition may be, for example, a voltage value that is known to be associated with an under voltage condition. If the measured or calculated voltage (Vdc) across the DC link 218 is greater than the DC link condition, the DC link condition is met and the status of the voltage (Vdc) indicator is positive. If the measured or calculated voltage (Vdc) is less than or equal to the DC link condition, the DC link condition is not met and the status of the voltage (Vdc) indicator is negative.

The indicator of the voltage (V_{ICL}) across the pre-charge impedance 242 is compared to a pre-charge voltage condition (330). The pre-charge voltage condition is a voltage value. If the measured or calculated voltage (V_{ICL}) is less than the pre-charge voltage condition, the pre-charge voltage condition is met and the status of the voltage (V_{ICL}) indicator is positive. Otherwise, the pre-charge voltage condition is not met and the status of the indicator (V_{ICL}) is negative.

The indicator of the input voltage (V_{SENSE}) is compared to the input voltage condition (340). The input voltage condition is a voltage value. If the input voltage (V_{SENSE}) is greater than the input voltage condition, the input voltage condition is met and the status of the input voltage (V_{SENSE}) indicator is positive. Otherwise, the input voltage condition is not met and the status of the input voltage (V_{SENSE}) is negative.

If the status of any indicator is negative, the process 300 determines whether the relays M1, M2, M3 are off (345). If the relays M1, M2, M3 are off, the process 300 returns to (310) and continues to monitor the electrical measurements 231. If the relays M1, M2, M3 are on, the control system 230 issues a command to the relays M1, M2, M3 to turn them off (347) and the process 300 returns to (310). The relays M1, M2, and M3 are off and current continues to flow in the pre-charge path 240, and the process 300 continues to monitor the electrical measurements 231.

If the status of all of the indicators is positive, all of the conditions have been met and the control system 230 issues a command to the relays M1, M2, M3 to turn on (350). When the relays M1, M2, M3 are on, gate current flows into the thyristors 215-1, 215-3, and 215-5, and the thyristors 215-1, 215-3, and 215-5 turn on and enter the forward conducting state when they experience a forward biased condition. Current flows through the thyristors 215-1, 215-3, 215-5 and into the DC link 218. Current does not flow in the pre-charge path 240 because the pre-charge impedance 242 is greater than the impedance of the thyristors 215-1, 215-3, 215-5. The voltage across the capacitor Cdc of the DC link 218 reaches its maximum value and the power converter 210 operates in steady-state.

The process 300 returns to (310) via a decision path 351 and the relays M1, M2, and M3 remain on with the power converter 210 operating in steady state. The control system 230 continues to monitor the electrical measurements 231 and to check the conditions at (320), (340), (350).

This continued monitoring during steady state operation of the power converter 210 allows the control system 230 to react to brown-out conditions effectively. A brown-out condition occurs when the peak voltage provided by the grid 201 drops below the voltage across the DC link 218. During a brown-out condition, the voltage across the DC link 218 also drops. However, because the time constant of the capacitor Cdc is relatively large, the voltage across the DC link 218 changes much more slowly than the input voltage. Monitoring only the voltage across the DC link 218 may delay the detection of a brown-out condition such that the pre-charge path is not available for current flow before the brown-out condition ends. In this situation, when the brown-out condition ends, there is a voltage difference between the nodes 214a, 214b, 214c and the DC link 218, and this difference may cause inrush currents because current is unable to flow in the pre-charge path. Thus, delayed detection of a brown-out condition may lead to uncontrolled and/or high inrush currents.

However, in the process 300, if the status of any indicator V_{SENSE}, Vdc, V_{ICL} does not meet its respective condition, the relays M1, M2, and M3 are turned off (345) and (347). For example, if the input voltage (V_{SENSE}) falls below the input voltage condition value, the status of the indicator V_{SENSE} is negative, and the control system 230 causes the relays M1, M3, M3 to turn off. The input voltage falling below the input voltage condition value is a sign that a brown-out condition has begun. The time constant of the filtering capacitor Cflt is much less than the time constant of the DC link capacitor Cdc. Thus, the voltage across the sensing resistor 227 in the sensing circuit 225 changes more quickly after the brown-out condition begins than the voltage across the DC link 218. In another example, a brown-out condition may cause the polarity of the voltage across the pre-charge impedance 242 to reverse such that the pre-charge impedance voltage indicator (V_{ICL}) no longer meets the pre-charge impedance condition. The control system 230 causes the relays M1, M2, M3 to turn off when the pre-charge impedance voltage indicator (V_{ICL}) does not meet the pre-charge impedance condition.

Because the input voltage (V_{SENSE}) indicator (as measured indirectly at the resistor 227 or as measured directly) and the pre-charge impedance voltage (V_{ICL}) indicator change and react to the drop in input voltage of brown-out condition more quickly than the voltage across the DC link 218, monitoring all of the indicators (V_{SENSE}), (Vdc), (V_{ICL}) allows the control system 230 to more quickly detect and respond to a brown-out condition than a legacy system that only uses a measurement of the voltage across the DC link 218.

After the relays M1, M2, M3 are off, the thyristors 215-1, 215-3, 215-5 turn off when they experience a reverse blocking condition, and current begins to flow in the pre-charge path 240 instead of flowing through the thyristors 215-1, 215-3, 215-5. As a result, when the input voltage (V_{SENSE}) recovers from the brown-out condition and has a peak voltage that is greater than the voltage across the DC link 218, current flows in the pre-charge path 240 and uncontrolled and/or large inrush currents that would otherwise occur if the pre-charge path 240 was unavailable are avoided or minimized. In this way, the control system 230 handles brown-out and brown-in conditions effectively and quickly.

The control system 230 turns the relays M1, M2, M3 on when the input voltage (V_{SENSE}) is greater than the DC link voltage value, the voltage (V_{ICL}) across the pre-charge impedance is less than the pre-charge voltage impedance condition value, and the voltage (Vdc) across the DC link 218 is greater than the DC link condition. After the relays M1, M2, M3 are turned on, gate current flows in the thyristors 215-1, 215-3, 215-5, which turn on when they experience a forward bias condition. As a result, the power converter 210 resumes steady-state operation after the brown-out and brown-in conditions end.

FIGS. 4-9 relate to other power converters that may be used with the control system 230 and the process 300.

FIG. 4 is a schematic of a system 400 that includes a power converter 410. The power converter 410 is similar to the power converter 210 (FIG. 2), except the power converter 410 includes a pre-charge path 440 that is different from the pre-charge path 240 (FIG. 2). In the power converter 410, the pre-charge path 240 is only connected to a single phase and only a single phase of the input voltage is used to pre-charge the DC link 218. Although using more than one phase to pre-charge the DC link 218 results in a quicker pre-charge sequence and less variation in the voltage across the pre-charge impedance, the single-phase pre-charge arrangement of FIG. 4 uses fewer components and may be less expensive.

In the example of FIG. 4, the pre-charge path 440 includes a diode DI in series with a pre-charge impedance 424. The pre-charge impedance 442 may be a resistor or an inrush current limiter (ICL). The diode DI is connected to the intermediate node 214c, and the pre-charge impedance 424 is connected to the DC link 218. The diode DI and the pre-charge impedance 442 are rated for relatively low currents compared to the contactors that are used in the pre-charge path of some legacy approaches. When the relays M1, M2, M3 are off, current flows in the pre-charge path 440. When the relays M1, M2, and M3 are on and the thyristors are in the forward conducting state, current flows in the thyristors 215-1, 215-3, 215-5 (in a power path) because the pre-charge impedance 424 has a much greater impedance than the thyristors.

The system also includes a sensing circuit 425. The sensing circuit 425 The sensing circuit 425 includes diodes D7, D8, and D9 that are connected to the intermediate nodes 214a, 214b, 214c, respectively, and to a voltage divider that includes a resistor 426, a resistor 427, and a filtering capacitor Cflt in parallel with the resistor 427. The voltage across the resistor 427 provides the indication (V_{SENSE}) of the input voltage at the intermediate nodes 214a, 214b, 214c. Although the system 400 is shown with the sensing circuit 425, the system 400 also may be used with the sensing circuit 225 (FIG. 2).

FIG. 5 is a schematic of a system 500 that includes a power converter 510 that may be used with the control system 230 and controlled with the process 300. The power converter 510 is similar to the power converter 210 (FIG. 2), except the power converter 510 does not include the sensing circuit 225 (FIG. 2). Instead, the indication of the input voltage (V_{SENSE}) is measured directly at the intermediate nodes 214a, 214b, 214c and the direct measurement is provided to the control system 230 for use in the process 300. The direct measurement of the input voltage may include a measurement circuit (not shown), such as a voltage divider at each intermediate node 214a, 214b, 214c to facilitate measurement of the input voltage.

The power converter 510 includes a pre-charge path 540 that includes the diode DI in series with the pre-charge impedance 242, with the diode DI electrically connected to the intermediate node 214a and the pre-charge impedance 242 electrically connected to the DC link 218. Thus, in the example shown in FIG. 5, only one phase (phase a) is used to pre-charge the DC link 218. However, other implementations are possible. For example, the power converter 210 may be implemented to include a pre-charge path that is connected to all three intermediate nodes 214a, 214b, 214c (such as shown in FIG. 2) or to two of the three intermediate nodes 214a, 214b, 214c.

FIG. 6 is a schematic of a system 600 that includes a power converter 610. The power converter 610 may be used with the control system 230 and the process 300. The power converter 610 includes a rectifier 617, the DC link 218, and the inverter 219. The rectifier 617 is a diode-diode rectifier that includes diodes DI and D4, which are connected to an intermediate node 614a, diodes D3 and D6, which are connected to an intermediate node 614b, and diodes D5 and D2, which are connected to an intermediate node 614c. The diodes D1, D3, and D5 are directly connected to the DC link 218. The diode D4 is connected to the DC link 218 through a first soft charge circuit SC1, the diode D6 is connected to the DC link 218 through a second soft charge circuit SC2, and the diode D2 is connected to the DC link 218 through a third soft charge circuit SC3. The soft charge circuit SC1, SC2, and SC3 allow the DC link 218 to be pre-charged at start up.

The soft charge circuit SC1 includes a relay MI and a first soft charge impedance Rscl in parallel with the relay M1. The soft charge circuit SC2 includes a relay M2 and a soft charge impedance Rsc2 in parallel with the relay Rrsc2. The soft charge circuit SC3 includes a relay M3 and a soft charge impedance Rsc3 in parallel with the relay M3. The relays M1, M2, M3 are contactors that are controlled by the control system 230 based on the process 300. The soft charge impedances Rsc1, Rsc2, and Rsc3 may be may be a resistors or inrush current limiters.

Referring also to FIG. 3, when AC power is initially applied to the power converter 610, the relays M1, M2, M3 are off and the diodes D4, D6, D8 are connected to the DC link 218 through the respective soft charge impedance Rsc1, Rsc2, Rsc3. Current flows through the pre-charge paths (the soft charge impedances Rsc1, Rsc2, Rsc3) and the voltage across the DC link 218 increases.

The control system 230 accesses electrical measurements 631. The electrical measurements 631 are measurements from voltage and/or current sensors (not shown) in the power converter 610. The electrical measurements 631 include an indication (Vdc) of the voltage across the DC link 218, an indication of the voltage across the soft charge impedances Rsc1, Rsc2, Rsc3, and an indication of the input voltage (V_{SENSE}) at the intermediate nodes 614a, 614b, 614c. In the example of FIG. 6, the indication of the input voltage (V_{SENSE}) is a direct measurement of the voltage at the nodes 614a, 614b, 614c. Other implementations are possible. For example, the power converter 610 may include a sensing circuit to such as the sensing circuit 225 of FIG. 2 to measure the indication of the input voltage.

The indication (Vdc) is compared to the DC link condition (320), the indication of the voltage across the soft charge impedances Rsc1, Rsc2, Rsc3 is compared to the pre-charge voltage condition (330), and the indication of the input voltage (V214a, 214b, 214c ) is compared to the input voltage condition (340). If all of the indications have a positive status, the control system 230 issues a command to turn on the relays M1, M2, M3, bypassing the soft charge impedances Rsc1, Rsc2, Rsc3. The power converter 610 begins steady state operation.

Because the rectifier 617 is a diode-diode rectifier, no gate control is included. However, the state of the relays M1, M2, M3 still determines whether or not the pre-charge paths through the soft charge impedances Rsc1, Rsc2, Rsc3 are bypassed and brown-out conditions may be more quickly detected than in a legacy approach that only uses the voltage across the DC link 218 to determine whether to close the relays.

FIGS. 7 and 8 show other implementations of the system 600. FIG. 7 is a schematic of a system 700 that includes a power converter 710. The power converter 710 may be used with the control system 230 and the process 300. The power converter 710 is the same as the power converter 610 (FIG. 6), except the power converter 710 includes only the soft charge circuits SC1 and SC3 and does not include the soft charge circuit SC2. In other words, the power converter 710 includes two soft-charge impedances instead of three. The amplitude of the soft-charge (or pre-charge) current is the same as in the power converter 610, but the soft charge time is longer in the system 700 because there is no pre-charge path connected to the intermediate node 214b.

FIG. 8 is a schematic of a system 800 that includes a power converter 810. The power converter 810 may be used with the control system 230 and the process 300. The power converter 810 is also the same as the power converter 610 (FIG. 6), except the power converter 810 includes only the soft charge circuit SCI and does not include the soft charge circuits SC2 and SC3. In other words, the power converter 810 includes one soft-charge impedance instead of three and uses only one phase of the input voltage (phase a in this example) to pre-charge the DC link 218. The amplitude of the soft-charge (or pre-charge) current is the same as in the power converter 810, but the soft charge time is longer in the system 800 because there is no pre-charge path connected to the intermediate node 214b or the intermediate node 214c. For example, the soft charge time for the system 800 may be three times as long as in the system 600. Nonetheless, the power converters 710 and 810 may be used with the control system 230 and the process 300 to efficiently and quickly detect and handle brown-out conditions.

FIG. 9 is a schematic of a system 900. The system 900 includes the diode-diode rectifier 617 and a DC link 918. The diode-diode rectifier 617 converts AC current from the source 201 into the rectified current Ipc, which is provided to the DC link 918. The DC link 918 includes series capacitors Cdc1 and Cdc2 between a positive (P) bus and a negative (N) bus. Each capacitor Cdc1 and Cdc2 is in parallel with a respective resistor Rc1, Rc2. The indicator Vdc is the voltage between the positive and negative buses (the voltage across the capacitors Cdc1 and Cdc2). The DC link 218 may be used in the system 900 instead of the DC link 918. Moreover, the DC link 918 may be used in place of the DC link 218 in any of the systems 200, 400, 500, 600, 700, or 800.

The DC link 918 is connected to a load 991 through a load switch 990 (for example, a contactor). The load 991 may be, for example, an inverter such as the inverter 219, or to a DC load.

The system 900 includes a three-phase contactor 952, and inrush current limiters 942-1, 942-2, and 942-3. The three-phase contactor 952 includes three contactors, with one contactor being connected in series with each diode D4, D6, and D2 at a respective node 949-1, 948-2, 949-3. The ICL 942-1 is in parallel with the contactor that is in series with the diode D4, the ICL 942-2 is in parallel with the contactor that is in series with the diode D6, and the ICL 942-3 is in parallel with the contactor that is in series with the diode D2.

Each node 949-1, 949-2, 949-3 is connected via a respective diode to a voltage divider that includes resistors RI and R2, with a capacitor C2 in parallel with the resistor R2. In the implementation shown in FIG. 9, the indication VICI is the voltage across the resistor R2, which tracks the voltage across the ICLs 942-1, 942-2, 942-3.

The system 900 also includes a sensing circuit 925 that monitors the input voltage from the source 201. The sensing circuit 925 is a voltage divider with series resistors R3, R4, R5, and a resistor R6, with a capacitor Cl in parallel with the resistor R6. The resistor R3 is connected to the intermediate node 618a through a diode D7, to the intermediate node 618b through a diode D8, and to the intermediate node 618c through a diode D9. The indicator Vsense is the voltage across the resistor R6. The value of V_{SENSE} tracks the voltage of the intermediate nodes 618a, 618b, 618c and is used to monitor the voltage of the AC source 202.

Referring also to FIG. 3, when AC power is initially applied to the rectifier 617, the three-phase contactor 952 is off, and the diodes D4, D6, D8 are connected to the DC link 918 through the ICLs 942-1, 942-2, 942-3. Current flows through the pre-charge paths (the ICLs 942-1, 942-2, 942-3) and the voltage across the DC link 918 increases. The indication V_{SENSE} tracks the voltage of the AC source 202 and rises as the AC power is applied to the rectifier 617. The contactor 990 is closed, and power is applied to the load 991.

The control system 230 accesses indications Vdc, V_{ICL}, and V_{SENSE}. The indication (Vdc) is compared to the DC link condition (320), the indication of the voltage across the VCLs 942-2, 942-2, 942-3 is compared to the pre-charge voltage condition (330), and the indication of the input voltage (V_{SENSE}) is compared to the input voltage condition (340). If all of the indications have a positive status, the control system 230 issues a command to turn on the three-phase contactor 952. When the three-phase contactor 952 is on, the ICLs 942-1, 942-2, 942-3 are bypassed and the system 900 operates in steady-state.

A brown-out condition occurs, V_{SENSE}falls below the input voltage condition, and the control system 230 opens the three-phase contactor 952 such that current flows through the ICLs 942-1, 942-2, 942-3. The load 991 is still connected to the DC link 918, the ICLs 942-1, 942-2, 942-3 limit the current to the load and Vdc drops.

After the AC voltage is restored, the V_{SENSE}indicator increases and then exceeds the input voltage condition, and Vdc increases. When V_{ICL} drops below the pre-charge voltage condition, all three conditions are met and the three-phase contactor 952 is closed. The contactor 990 is closed and power is applied to the load 991.

These and other implementations are within the scope of the claims. For example, the system 200 (FIG. 2) may include the sensing circuit 425 (FIG. 4) instead of the sensing circuit 225.

What is claimed is:

1. A power converter comprising:
an electrical network comprising: a plurality of intermediate nodes, wherein each intermediate node is configured to connect to one phase of an alternating current (AC) electrical power source, the electrical network is configured to convert AC electrical current to direct current (DC) electrical current, and the electrical network comprises a plurality of electronic switches;
a DC link electrically connected to the electrical network;
a pre-charge path electrically connected to the DC link, the pre-charge path comprising a pre-charge impedance;
a control path electrically connected to one of the electronic switches, the control path comprising a relay; and
a control system configured to:
analyze a plurality of electrical measurements from the power converter to determine a status output; and
determine whether to control the relay to change state based on the status output.

2. The power converter of claim 1, wherein the plurality of electrical measurements from the power converter comprise: an indication of a voltage across the pre-charge impedance, an indication of a voltage of the AC power source, and an indication of a voltage across the DC link; and
the control system is configured to analyze the indication of a voltage across the pre-charge impedance, the indication of a voltage of the AC power source, and the indication of a voltage across the DC link to generate the status output.

3. The power converter of claim 1, wherein the plurality of electronic switches comprises at least one controllable electronic switch electrically connected to each intermediate node; the control path comprises a plurality of control branches; each control branch comprises a relay; and each control branch is electrically connected to a control node of one controllable electronic switch; and wherein
the control system is configured to determine whether to control all of the relays to change state based on the status output.

4. The power converter of claim 3, wherein the controllable electronic switch comprises a thyristor; and the control node comprises a gate on the thyristor.

5. The power converter of claim 4, wherein the pre-charge path is electrically connected to one of the intermediate nodes and the DC link.

6. The power converter of claim 4, wherein the pre-charge path comprises a plurality of pre-charge branches, and each pre-charge branch is electrically connected to one of the intermediate nodes and the pre-charge impedance.

7. The power converter of claim 6, further comprising a voltage sensing impedance electrically connected to the input nodes, and wherein the plurality of electrical measurements comprise an indication of a voltage across the pre-charge impedance, an indication of a voltage of the AC power source measured at the voltage sensing impedance, and an indication of a voltage across the DC link.

8. The power converter of claim 1, wherein the relay comprises a contactor.

9. The power converter of claim 1, wherein the plurality of electronic switches comprise diodes, and two diodes are electrically connected to each intermediate node; the relay is in series with one of the diodes; and the pre-charge impedance is in parallel with the relay.

10. The power converter of claim 1, wherein the plurality of electronic switches comprise diodes, and two diodes are electrically connected to each intermediate node; the control path comprises a plurality of control branches, each control branch comprising a relay in series with one of the diodes; and the pre-charge path comprises a plurality of pre-charge paths, each pre-charge path comprising a pre-charge impedance in parallel with one of the relays.

11. A control system comprising:
an analysis module configured to: analyze a plurality of electrical measurements from a power converter to determine a status output; and
a control module configured to: determine whether to turn on a relay in a control path of the power converter based on the status output, wherein electrical current is provided to a DC link of the power converter through a pre-charge path when the relay is off, and turning on the relay causes one or more electronic switches in the power converter to conduct current such that electrical current is provided to the DC link of the power converter through a power path when the relay is on.

12. The control system of claim 11, wherein, to analyze the plurality of electrical measurements, the analysis module is configured to compare each electrical measurement to a pre-determined condition associated with that electrical measurement to produce a result for that electrical measurement; and the status output comprises the result for each electrical measurement.

13. The control system of claim 12, wherein the control module is configured to turn on the relay only if each result meets the associated pre-determined condition such that electrical current is provided to the DC link of the power converter through the power path only when each electrical measurement meets the associated pre-determined condition.

14. An apparatus comprising:
an electrical network comprising:
a plurality of intermediate nodes, wherein each intermediate node is configured to connect to one phase of an alternating current (AC) electrical power source, the electrical network is configured to convert AC electrical current to direct current (DC) electrical current; and
an electrical network comprising a phase branch connected to each intermediate node, each phase branch comprising a thyristor and a diode;
a DC link electrically connected to the electrical network;
a pre-charge path electrically connected to at least one of the intermediate nodes and the DC link, the pre-charge path comprising a pre-charge impedance; and
a plurality of control paths, each control path connected to one of the intermediate nodes and a gate of one of the thyristors, and each control path comprising a relay.

15. The apparatus of claim 14, wherein the pre-charge path is connected to all of the intermediate nodes.

16. The apparatus of claim 15, further comprising a sensing impedance connected to all of the intermediate nodes, wherein a voltage across the sensing impedance provides an indication of a voltage input to the apparatus.

17. A method comprising:
accessing a plurality of electrical measurements from a power converter, the plurality of measurements comprising: an indication of a voltage across a pre-charge impedance; an indication of a voltage of an AC power source connected to the power converter, and an indication of a voltage across a DC link of the power converter;
comparing at least two indications to an associated specification to produce at least two status outputs;
analyzing the at least two status outputs to determine whether to change a state of a relay in the power converter;
if it is determined to turn on the relay, controlling the relay to turn on to thereby cause electrical current to flow in an electronic switch connected to the relay such that electric current flows through a power path to the DC link, the power path comprising the electronic switch; and
if it is determined to turn off the relay, controlling the relay to turn off such that electric current flows through a pre-charge impedance to the DC link.

18. The method of claim 17. wherein each indication is compared to an associated specification to produce three status outputs, and the three status outputs are analyzed to determine whether to change the state of the relay.
